(19) United States
(12) Patent Application Publication
(10) Pub. No.: US 2009/0201821 A1
(43) Pub. Date: Aug. 13, 2009

(54) SYSTEM AND METHOD FOR DETECTING EARLY LINK FAILURE IN AN ETHERNET NETWORK

(76) Inventors: James D. Barnette, Austin, TX (US); Jason C. Rock, Austin, TX (US); Mandeep S. Chadha, Austin, TX (US)

Correspondence Address: Daniel M. Cavanagh;Klein, O'Neill & Singh, LLP, Suite 204, 43 Corporate Park, Irvine, CA, 92606, US

(21) Appl. No.: 12/029,195

(22) Filed: Feb. 11, 2008

(51) Int. Cl. H04L 12/26

(52) U.S. Cl. 370/245

(57) ABSTRACT

A system and method for providing an early indication of link failure in an Ethernet network. In some embodiments an Ethernet PHY determines a link failure if the PHY loses descrambler synchronization, if remote receiver status is determined to indicate a remote receiver failure, or if link status indicates a link failure.

### BACKGROUND OF THE INVENTION

The present invention relates generally to network communications, and more particularly to a system and method for detecting early link failure in an Ethernet network.

Network communications involve a number of different technologies, standards and protocols. Ethernet networks are perhaps the most pervasive type of network in use today. While becoming a de facto standard may have been based on history, Ethernet has evolved with the times to accommodate the networking needs of the present day.

The nature of the use of Ethernet networks has also changed over time. Communications involving the exchange of digital data have been growing exponentially since the advent and now widespread use of the Internet. A variety of new applications make use of Ethernet networks, including, for example, applications exchanging voice and/or video data. While some data transported by Ethernet networks is not time sensitive, other data is time sensitive or even time critical. In the case of time sensitive data, rigorous demands for predictable timing can be required of a network. Applications sensitive to the timing of data can include, for example, quality of service (QOS) and synchronization type applications. More specific applications include voice over internet protocol (VOIP), data center, and backhaul communication applications. A number of time sensitive type applications may make demands of networks not contemplated by the drafters and developers of standards related to such networks.

### SUMMARY OF THE INVENTION

In one aspect the invention provides a method for detecting a link failure in an Ethernet network comprising a local node coupled to a remote node by a link, the method comprising receiving a descrambler status signal, receiving a remote receiver status signal, receiving a link status signal, and generating a link failure signal based on the descrambler status signal, the remote receiver status signal, and the link status signal.

In another aspect the invention provides a system for detecting a link failure in an Ethernet network comprising a local node coupled to a remote node by a link, the system comprising link failure circuitry configured to receive a descrambler status signal, a remote receiver status signal, and a link status signal, wherein the link failure circuitry is configured to generate a link failure signal based on the descrambler status signal, the remote receiver status signal, and the link status signal.

In another aspect the invention provides an Ethernet switch configured to route data from a first port to a second port, the first port and the second port each configured for coupling to a transmission media connected to computer systems, the Ethernet switch including a switch coupled to each of the ports by at least a media access controller integrated circuit and a physical layer integrated circuit, the physical layer integrated circuit configured to receive data from and transmit data to the transmission medium, the physical layer integrated circuit including circuitry for detecting a link failure in an Ethernet network, the circuitry comprising link failure circuitry configured to receive a descrambler status signal, a remote receiver status signal, and a link status signal, receiver circuitry configured to generate the descrambler status signal and the remote receiver status signal, and link monitor circuitry configured to generate the link status signal, wherein the link failure circuitry is configured to generate a link failure signal based on the descrambler status signal, the remote receiver status signal, and the link status signal.

In another aspect the invention provides a method for detecting a link failure in an Ethernet network, the Ethernet network comprising an Ethernet switch configured to route data from a first port to a second port, the first port and the second port each configured for coupling to a transmission media connected to computer systems, the Ethernet switch including a switch coupled to each of the ports by at least a media access controller integrated circuit and a physical layer integrated circuit, the physical layer integrated circuit configured to receive data from and transmit data to the transmission medium and to execute the method, the method comprising: generating a descrambler status signal, generating a remote receiver status signal, generating a link status signal, receiving the descrambler status signal, the remote receiver status signal, the link status signal, and generating a link failure signal based on the descrambler status signal, the remote receiver status signal, and the link status signal.

These and other aspects of the invention are more fully comprehended upon review of this disclosure.

### BRIEF DESCRIPTION OF THE DRAWINGS

FIG. 1 is a block diagram of an Ethernet transceiver including a MAC block in communication with a PHY block having a control block in accordance with aspects of the invention;

FIG. 2 is a schematic block diagram of an Ethernet PHY including a link failure block in accordance with aspects of the invention; and

FIG. 3 is a flow diagram of a process for generating a link failure signal in accordance with aspects of the invention.

### DETAILED DESCRIPTION

In one aspect of the invention, link failure circuitry receives various signals from an Ethernet physical layer (PHY) and determines whether a link failure has occurred. In some embodiments, the link failure circuitry can report a link failure in less than 1 millisecond (ms). In one embodiment, the Ethernet PHY signals used by the link failure circuitry to determine link failure are 1000-Base-T type signals. In some embodiments, the link failure circuitry can be incorporated into an Ethernet switch having one or more ports coupled to a transmission medium. In such case, the Ethernet switch can include MAC circuitry and PHY circuitry. In other embodiments, the link failure circuitry can be incorporated into an Ethernet transceiver. In such case, the Ethernet transceivers can support a number of different Ethernet communication speeds and protocols relating to incremental versions of the governing standards.

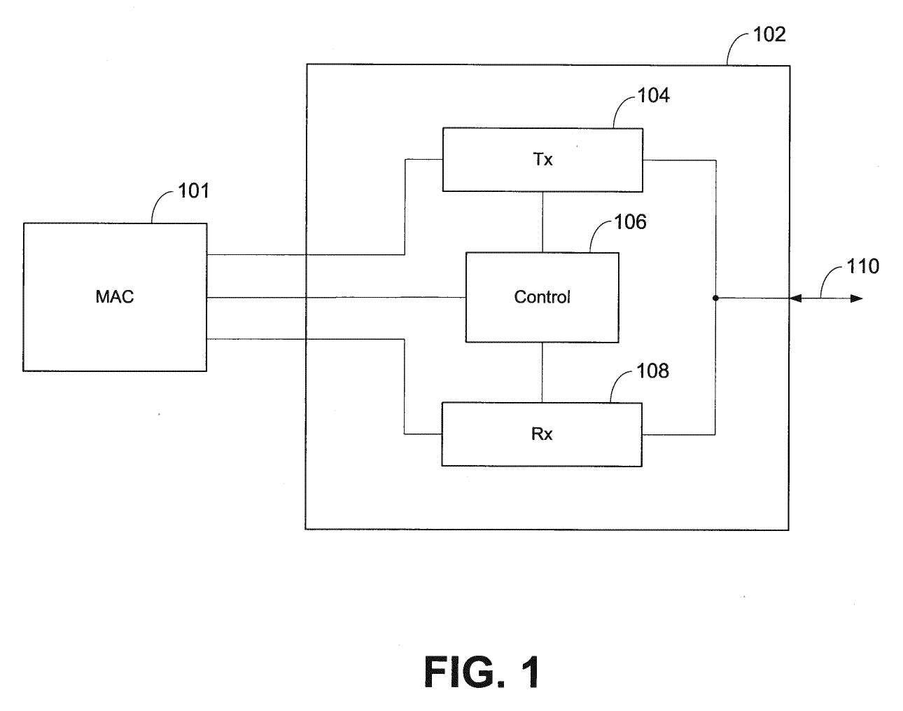

FIG. 1 is a partial block diagram of an Ethernet transceiver in accordance with aspects of the invention. The transceiver includes an Ethernet compliant media access control (MAC) block 101 in communication with a Ethernet physical layer (PHY) 102. In many embodiments the MAC and the PHY are implemented as separate chips or chipsets. The PHY is coupled to a communication medium 110, such as a twisted pair cable or other suitable Ethernet communication medium. In general another end of the communication medium is coupled to a PHY forming part of another node in a network. The PHY 102 includes a transmit (Tx) chain 104 and a receive (Rx) chain 108. The transmit chain 104 generally processes data from the MAC, formats the data for transmission, and transmits the data over the communication medium 110. Similarly, the receive chain 108 receives data over the communication medium 110, processes the received data, and provides formatted data to the MAC.

The PHY 102 also includes logic circuitry providing a control block 106. The control block receives and provides information from and to the MAC, the transmit chain, and the receive chain. In general, the control block determines transmission and reception status of the transmit and receive chains, which considered together can be thought of as a transceiver. For example, the control block may determine auto-negotiation status for communicating with other nodes, whether another node is available for communication, whether the transceiver is receiving valid data from another node, a communication mode, and other matters. In general, the control block determines PHY states and status signals in accordance with applicable Ethernet standards. For example, in one embodiment the control block may determine status and signals, except as discussed to the contrary herein, in accordance with clause 40 (Physical Coding Sublayer (PCS), Physical Medium Attachment (PMA) sublayer and baseband medium, types 1000BASE-T) of Part 3 of The IEEE Std. 802.3, incorporated by reference herein.

Clause 40 of the IEEE 802.3 specification defines minimum time periods for notification of link drop of 750 ms or 350 ms, depending on whether the Ethernet PHY is configured as a master or a slave. For a number of Ethernet applications, a link drop notification period of 350 ms or 750 ms may be too long for the application to function properly. For example, applications incorporating Synchronous Ethernet ITU G.8261, a protocol enabling precise synchronization of clocks, may need notification of a potential link drop in a shorter period of time.

Accordingly, the control block additionally provides a link failure signal. In many embodiments the link failure signal is provided to the MAC, and in some embodiments the link failure signal is provided on an output pin of the PHY. For example, in some embodiments the control block receives signals indicative of status of a remote receive link, status of descrambler synchronization at the local receive block in the receive chain, and link status. The signal indicative of status of the remote receive link indicates whether the remote receiver has failed. The signal indicative of descrambler synchronization indicates whether the local receiver has failed. The signal indicative of link status also indicates failure of one or both of the local or remote receivers, or the intervening communication medium.

Accordingly, the control block generates the link failure signal based on the remote receive status, descrambler synchronization and link status signals. In some embodiments the link failure signal indicates FAIL whenever any of remote receiver status, descrambler synchronization status, or link status indicates a failure. The link failure signal can provide a link drop indication in a very short period of time. In one embodiment, the link failure signal provides the link drop indication in less than 1 ms after an actual link drop/failure. The link failure signal can be distributed to any of the transmit, receive or MAC blocks.

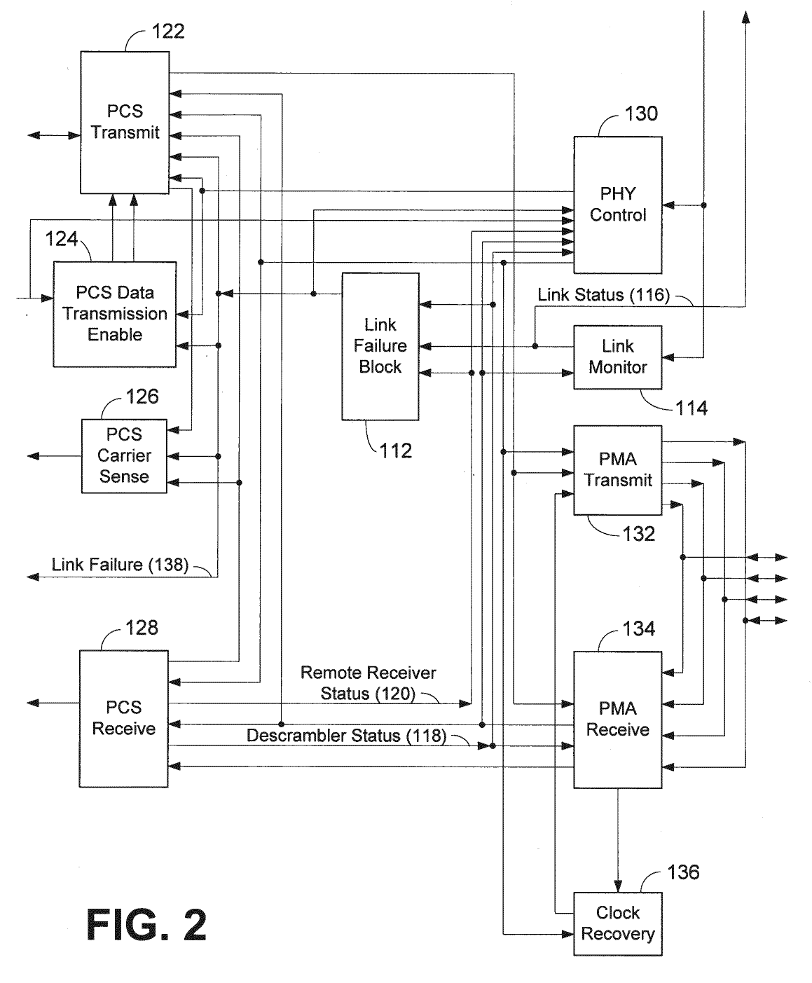

FIG. 2 is a schematic block diagram of a Ethernet PHY including a link failure block 112 in accordance with aspects of the invention. The PHY includes a physical coding sublayer (PCS), the link failure block 112, and a physical medium attachment (PMA sublayer). The link failure block 112 is coupled to the PCS and the PMA sublayer. The PCS includes a PCS transmit block 122 coupled to a PCS data transmission enable block 124 coupled to a PCS carrier sense block 126 coupled to a PCS receive block 128. The PMA sublayer includes a PHY control block 130 coupled to a link monitor block 114, a PMA transmit block 132 coupled to a PMA receive block 134 coupled to a clock recovery block 136.

The link failure block 112 receives a link status signal 116 from the link monitor block 114. The link failure block 112 receives a remote receiver status signal 120 and a descrambler status signal 118 from the PCS receiver block/circuitry 128. The link failure block 112 provides a link failure signal 138 to the PCS transmit block 122, the PCS data transmission enable block 124, the PCS carrier sense block 126, the MAC, and the PHY control block 130. In some embodiments, the link failure block is coupled to other blocks of the PCS and the PMA sublayer.

The remote receiver status signal can be generated by the PCS receive block 128 based on the status of the receive link at the remote PHY as reported by the remote PHY. The remote PHY can communicate this information via a “loc_rcvr_status” parameter, which can be provided to the PCS receive block. The remote receiver status signal can be used to communicate whether reliable operation of the remote PHY is detected or not. In one embodiment, the criteria for determining whether reliable operation of the remote PHY is detected can be decided by the implementer of the PCS receive block. In one embodiment, for example, the criteria can be based on asserting the remote receiver status signal is “NOT_OK” until the “loc_rcvr_status” parameter is “OK” and then asserting the detected value of the remote receiver status signal after proper PCS receive decoding is achieved. In such case, the remote receiver status signal can be a digital signal. In one embodiment, the remote receiver status signal is referred to as “rem_rcvr_status”.

The descrambler status signal can be generated by the PCS receive block 128 based on the status of the descrambler for the local PHY. The descrambler status signal can be used to convey whether the descrambler has achieved synchronization. In accordance with the 802.3 specification, a scrambler is used in the transmit path to ensure sufficient transitions in the transmitted data to support clock recovery. Data transmitted to the medium is generally scrambled using a polynomial cipher. The descrambler then reverses the scrambling operation to properly recover the data using the same polynomial cipher. In the illustrated embodiment, the descrambling is done within the PCS receive block. In one embodiment, the descrambler status signal takes a value of “OK” indicating that the descrambler has achieved synchronization, and “NOT_OK” indicating that the descrambler has not synchronized. In such case, the descrambler status signal can be a digital signal. In one embodiment, the descrambler status signal is referred to as “scr_status”.

The link status signal can be generated by the link monitor block 114 and is indicative of the status of the medium used for data transport by the Ethernet PHY. In several embodiments, the link status signal is used by a number of PCS and PMA blocks for various control functions. In one embodiment, the link status signal can take any of three values including “FAIL” indicating that no valid link is established, “READY” indicating that the link is intact and ready to be established, and “OK” indicating that a valid link has been established and that signals can be reliably received from the remote PHY. In another embodiment, the link status signal can take the values of “FAIL” and “OK”. In such case, the link status signal can be a digital signal.

In one embodiment, the link failure block and the link monitor block are implemented in a single block. In some embodiments, the link failure block receives other signals and/or additional signals. For example, the link failure block can be coupled to any number of signals available at the PHY control block 130 or other PMA sublayer blocks. In one embodiment, the remote receiver status signal and the descrambler status signal are generated by the PCS receive block 128. In other embodiments, the remote receiver status signal and the descrambler status signal can be generated by other PHY components. In one embodiment, the link status signal is generated by the link monitor block/circuitry 114. In another embodiment, the link status signal can be generated by another PHY component.

In some embodiments, the link failure block is implemented within a single chip such as an ASIC. In one such embodiment, the link failure block is implemented within an ASIC functioning generally as an Ethernet transceiver. In other embodiments, the link failure block is implemented in multiple chips sharing information. In some embodiments, the link failure block can be implemented using any combination of processors, memory, discrete logic components, data buses and/or other processing elements that share information. In some embodiments, the link failure block is implemented within an ASIC that incorporates both digital components and analog components, such as a mixed-mode ASIC. In such case, any number of components common to an Ethernet transceiver can be included within the mixed-mode ASIC.

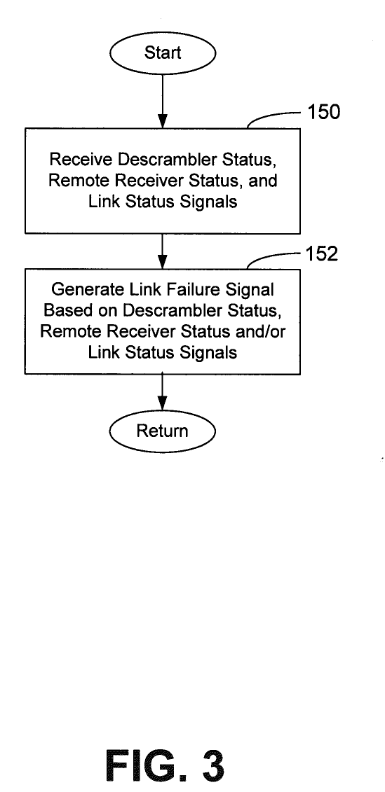

FIG. 3 is a flow diagram of a process for generating a link failure signal in accordance with aspects of the invention. In some embodiments, the process is performed by the link failure block of FIG. 2. In block 150, the process receives a descrambler status signal, a remote receiver status signal, and a link status signal. In block 152, the process generates the link failure signal based on the descrambler status signal, the remote receiver status signal and/or the link status signal. The process then returns.

In some embodiments, the process generates the link failure signal if any of the descrambler status, remote receiver status, or link status signals indicate failure. In other embodiments, other combinations of the descrambler status, remote receiver status, and link status signals can be used to generate the link failure signal. For example, in one embodiment, the process considers only one of the descrambler status, remote receiver status, and link status signals in generating the link failure signal. In some embodiments, the descrambler status, remote receiver status, and/or link status signals are considered in a particular sequence. In a number of embodiments, the process considers the descrambler status, remote receiver status, and/or link status signals simultaneously.

In several embodiments, the process generates the link failure signal in less than 1 ms from when a link failure on the Ethernet medium actually occurs. In a number of embodiments, the process generates the link failure signal in a sufficiently short period of time as to satisfy timing requirements for synchronous Ethernet standards such as IEEE 1588 and/or ITU G.8261.

The invention therefore provides a system and method for detecting early link failure in an Ethernet network. Although the invention has been described with respect to certain embodiments, it should be recognized that the invention may be practiced other than as specifically described, the invention comprising the claims and their insubstantial variations supported by this disclosure.

What is claimed is:

1. A method for detecting a link failure in an Ethernet network comprising a local node coupled to a remote node by a link, the method comprising:
receiving a descrambler status signal;
receiving a remote receiver status signal;
receiving a link status signal; and
generating a link failure signal based on the descrambler status signal, the remote receiver status signal, and the link status signal.

2. The method of claim 1, wherein the generating a link failure signal based on the descrambler status signal, the remote receiver status signal, and the link status signal comprises generating a link failure signal when any one of the descrambler status signal, the remote receiver status signal, and the link status signal, indicates failure.

3. The method of claim 1, wherein the link failure signal is generated within 1 millisecond of a link failure.

4. The method of claim 1, wherein the link failure signal is a value indicative of any of “FAIL”, “READY”, and “OK”.

5. The method of claim 1:
wherein the remote receiver status signal is generated by receiver circuitry; and
wherein the remote receiver status signal is indicative of a status of the link at the remote node as reported by the remote node.

6. The method of claim 1:
wherein the descrambler status signal is generated by receiver circuitry; and
wherein the descrambler status signal is indicative of a status of a descrambler at the local node.

7. The method of claim 1:
wherein the link status signal is generated by link monitor circuitry; and
wherein the link status signal is indicative of a status of the link between the local node and the remote node.

8. A system for detecting a link failure in an Ethernet network comprising a local node coupled to a remote node by a link, the system comprising:
link failure circuitry configured to receive a descrambler status signal, a remote receiver status signal, and a link status signal;
wherein the link failure circuitry is configured to generate a link failure signal based on the descrambler status signal, the remote receiver status signal, and the link status signal.

9. The system of claim 8, wherein the link failure circuitry is configured to generate the link failure signal when any one of the descrambler status signal, the remote receiver status signal, and the link status signal, indicates failure.

10. The system of claim 8, wherein the link failure signal is generated within 1 millisecond of a link failure.

11. The system of claim 8, wherein the link failure signal is a value indicative of any of “FAIL”, “READY”, and “OK”.

12. The system of claim 8:
wherein the remote receiver status signal is generated by receiver circuitry; and
wherein the remote receiver status signal is indicative of a status of the link at the remote node as reported by the remote node.

13. The system of claim 8:
wherein the descrambler status signal is generated by receiver circuitry; and
wherein the descrambler status signal is indicative of a status of a descrambler at the local node.

14. The system of claim 8:
wherein the link status signal is generated by link monitor circuitry; and
wherein the link status signal is indicative of a status of the link between the local node and the remote node.

15. An Ethernet switch configured to route data from a first port to a second port, the first port and the second port each configured for coupling to a transmission media connected to computer systems, the Ethernet switch including a switch coupled to each of the ports by at least a media access controller integrated circuit and a physical layer integrated circuit, the physical layer integrated circuit configured to receive data from and transmit data to the transmission medium, the physical layer integrated circuit including circuitry for detecting a link failure in an Ethernet network, the circuitry comprising:
link failure circuitry configured to receive a descrambler status signal, a remote receiver status signal, and a link status signal;
receiver circuitry configured to generate the descrambler status signal and the remote receiver status signal; and
link monitor circuitry configured to generate the link status signal;
wherein the link failure circuitry is configured to generate a link failure signal based on the descrambler status signal, the remote receiver status signal, and the link status signal.

16. The system of claim 15, wherein the link failure signal is generated within 1 millisecond of a link failure.

17. The system of claim 15, wherein the link failure signal is a value indicative of any of “FAIL”, “READY”, and “OK”.

18. A method for detecting a link failure in an Ethernet network, the Ethernet network comprising an Ethernet switch configured to route data from a first port to a second port, the first port and the second port each configured for coupling to a transmission media connected to computer systems, the Ethernet switch including a switch coupled to each of the ports by at least a media access controller integrated circuit and a physical layer integrated circuit, the physical layer integrated circuit configured to receive data from and transmit data to the transmission medium and to execute the method, the method comprising:
generating a descrambler status signal;
generating a remote receiver status signal;
generating a link status signal;
receiving the descrambler status signal, the remote receiver status signal, the link status signal; and
generating a link failure signal based on the descrambler status signal, the remote receiver status signal, and the link status signal.

19. The method of claim 18, wherein the link failure signal is generated within 1 millisecond of a link failure.

20. The method of claim 19, wherein the link failure signal is a value indicative of any of “FAIL”, “READY”, and “OK”.
